(19) United States
(12) Patent Application Publication
(10) Pub. No.: US 2015/0009651 A1
(43) Pub. Date: Jan. 8, 2015

(54) LED Lamp

(71) Applicants: Yu Lin Lee, Jhubei City (TW); GEOMETEK APPLICATION ENGINEERING CO., LTD., Jhubei City (TW)

(72) Inventor: Yu Lin Lee, Jhubei City (TW)

(73) Assignees: GEOMETEK APPLICATION ENGINEERING CO., LTD., Jhubei City (TW); Yu Lin Lee, Jhubei City (TW)

(21) Appl. No.: 14/147,687

(22) Filed: Jan. 6, 2014

(30) Foreign Application Priority Data
Jul. 5, 2013 (TW) 102124119

(51) Int. Cl. F21K 99/00

(52) U.S. Cl. CPC F21K 9/17
USPC 362/95; 362/219

(57) ABSTRACT

A LED lamp is provided. The LED lamp includes a tube and a plurality of LED light bar. The tube has a placement surface, and these LED light bar are disposed on the placement surface. Each LED light bar includes a circuit board and a plurality of LED lights, and these LED light is disposed on the circuit board. The LED light bar is mounted on the placement surface in a detachable manner.

### FIELD OF THE INVENTION

The present invention relates to a LED lamp, especially relates to a LED lamp having a plurality of LED light bar.

### BACKGROUND OF THE INVENTION

These years, the LED (Light Emitting Diode), with the advantage of its high brightness, energy saving, environmental protection, long life, etc., has been widely replaced of the traditional lighting fixtures. The most use of the traditional fluorescent tube has been replaced to the LED lamp. Please refer to FIG. 1, the FIG. 1 shows the prior art LED lamp 10, the LED lamp 10 includes a LED light bar 11, a heat dissipation substrate 12, an end cover 13, and a long tubular lamp cover 14. The LED light bar 11's top surface is adhered on the heat dissipation substrate 12 by the adhesive, a plurality of LED lights 111 is disposed on a bottom surface of the LED light bar 11, the end covers 13 are disposed at the end of the right side and the left side of the LED lamp 10, and the end cover 13 has two electrode pairs 131, the electrode pairs 131 can be plugged into an external socket (not shown), and the long tubular lamp cover 14 covers the circuit board 11 and connects with the heat dissipation substrate 12. Further, since in the normal circumstances, the LED lights 111 only switch on with the DC, so the LED lamp 10 will needs a built-in or external current converter 15 to switch on. The current converter 15 receives AC from electrode pairs 131 first, and then the current converter 15 will transfer the AC to the DC, and provide power to the LED lights 111. However, when the LED lamp 10 is failure or damage, is not easily to figure out the damaged parts is either the LED light bar 11 or the current converter 15. In addition, the LED light bar 11 is stick on the heat dissipation substrate 12 and is not easy to be detached, as long as there is a small part of the LED lights 111 is damaged, it will need to replace the entire set of LED lamp 10, and it's resulting in a waste of resources.

Therefore, how to design a LED lamp to facilitate to figure out the damage of the internal parts, and for more easily to replacement the LED light bar, is worthy to be considered by the person having ordinary skill in the art.

### SUMMARY OF THE INVENTION

The present invention is about a LED lamp, which includes a tube and a plurality of LED light bar, the tube having a placement surface, and these LED light bar is placed on the placement surface, each LED light bar includes a circuit boards and a plurality of LED lights, these LED lights is placed on the circuit boards, wherein the LED light bar is mounted on the placement surface in a detachable manner.

In the above LED lamp, the LED light bar which is locked on the placement surface by at least one screw.

In the above LED lamp, the LED light bar is locked on the placement surface by two screws, and these two screws are locked respectively on the two endpoints of the LED light bar.

In the above LED lamp, the LED lamp further includes a lamp cover, which is assembled with the tube, and the lamp cover is configured for the LED light bar's light emitting surface.

In the above LED lamp, a plurality of positioning blocks is placed on the placement surface, and each LED light bar is abutting against at least one positioning block.

In the above LED lamp, the placement surface has a plurality of magnetic blocks, and the LED light bar is placed on the placement surface by the magnetic blocks.

In the above LED lamp, the LED light bar has at least one plug, and at least one socket which is corresponding to the plug is placed on the placement surface, and the plug is shaped to make a interference fit with the socket, so as to make the LED light bar be mounted on the placement surface.

In the above LED lamp, the LED light bar which has a length between of 15 cm to 60 cm.

In the above LED lamp, the LED light bar has a length of 30 cm.

### BRIEF DESCRIPTION OF THE DRAWINGS

FIG. 1 shows a prior art of LED lamp 10.

FIG. 2 shows the first embodiment of the LED lamp 20.

FIG. 3 shows the second embodiment of the LED lamp 30

FIG. 4A and FIG. 4B shows the third embodiment of the schematic diagram of LED lamp 40.

FIG. 5 shows the fourth embodiment of the schematic diagram of LED lamp 50.

FIG. 6 shows the fifth embodiment of the schematic diagram of LED lamp 60.

FIG. 7 shows the sixth embodiment of the schematic diagram of LED lamp 70.

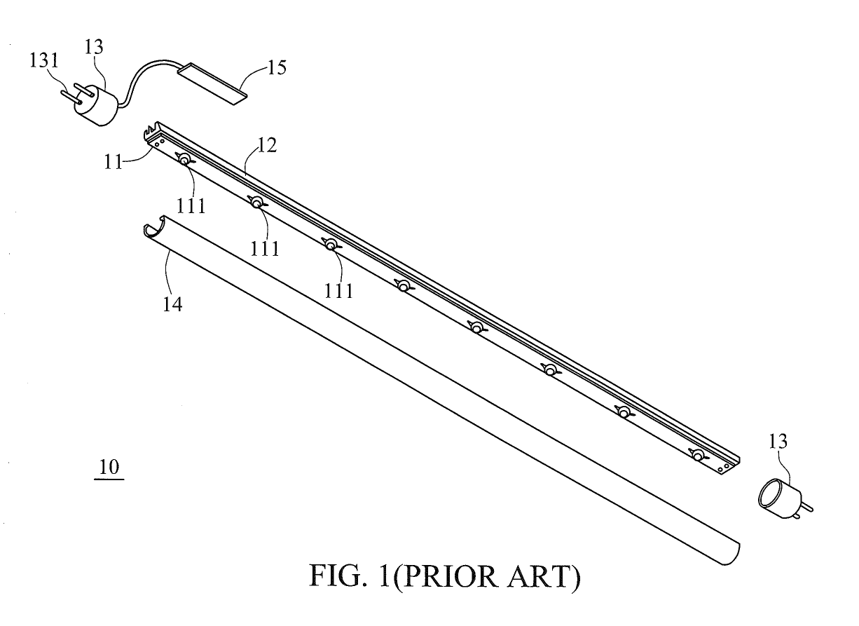

### DETAILED DESCRIPTION OF PREFERRED EMBODIMENTS

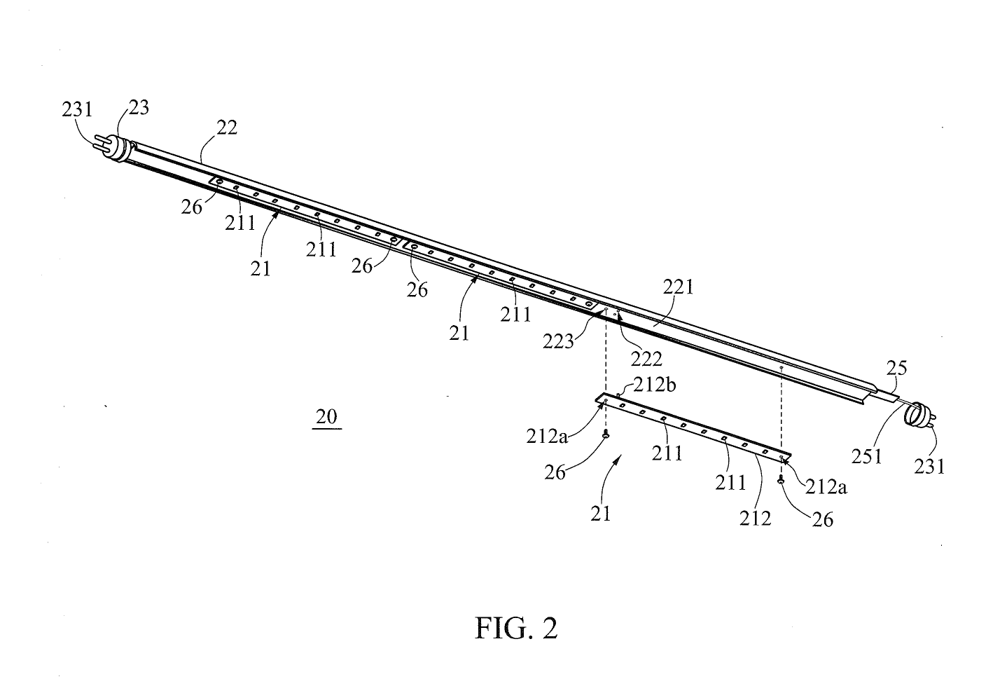

Refer to FIG. 2, FIG. 2 shows the first embodiment of the LED lamp 20, the LED lamp 20 includes a tube 22, a end cover 23, a current converter 25, a plurality of electrode pairs 231, and a plurality of LED light bar 21. The tube 22 has a placement surface 221, the placement surface 221 has a plurality socket 222 and a plurality of screw holes 223. The tube 22 is using the high heat conductive and low density metal material, for example: aluminum. The electrode pairs 231 is disposed in the end cover 23, the electrode pairs 231 is mainly configured to be connected with the external socket (not shown) and obtain the power for LED lamp 20. And the current converter 25 is engaged and assembled in the tube 22, and hide behind the placement surface 221. The current converter 25 includes an input wire 251, the input wire 251 is electrically connected to the electrode pairs 231, the AC power is transmitted to the input wire 251 from the electrode pair 231 and supplied to the current converter 25. And then the AC power is converted into DC power by the current converter 25. The LED light bar 21 includes a circuit board 212 and a plurality of LED lights 211, at each end of the surface of the circuit board 212 a through hole 212a is disposed, the LED lights 211 are disposed on the circuit board 212's bottom surface, and a plug 212b is disposed on the top surface of the circuit board 212. When the plug 212b is plugged into the socket 222 of the placement surface 221, the DC power will be supplied to the circuit board 212 from the current converter 25, and then supplied to the LED lamp 211. In order to make the LED light bar 21 be more firmed after being mounted to the placement surface 221, two screws 26 is passed through the through holes 212a at both ends of the circuit board 212, so as to make the LED light bar 21 firmly mounted on the placement surface 221. From the above, two screws 26 is used to lock the LED light bar 21 on the placement surface 221, but the person having ordinary skill in the art also can use only one screw 26 to lock the LED light bar 21 on the placement surface 221. Compared to the shortcomings of the traditional LED light bar 11 not easy to be dispatched, the LED lamp 20 in the embodiment can be simply dispatched by unlocking the screws 26 and be replaced by a new LED light bar 21 when the LED light bar 21 is damaged, and thus there is no need to replace the entire set of the LED lamp 20, it's greatly reducing the costs of maintenance incurred.

When the first embodiment of the LED lamp 20 is damaged, by observing the LED light bar 21, the user can see which major parts (the circuit board 212 or the current converter 25) is damaged the most, two kinds of failure to explain how to find out the damaged parts of the LED lamp 20 is cited in the following. First, when the LED light bar 21 has few LED lights 211 off, it should be the off LED lights 211 is damaged, then simply replace the LED light bar 21 having the off LED lights 211, and there is no need to replaced the other LED light bar 21. Second, when all the LED lights 211 which is on the LED light bar 21 are off, the current converter 25 is damaged the most, then the user just should replace the current converter 25 to repair the LED lamp 20.

From the above embodiment, compared with the traditional LED lamp 10, when the LED lamp 20 of the embodiment is damaged, It's easy to find out which is the damaged part, so as to replace the parts of LED lamp 20 conveniently. Furthermore, when few parts of LED lights 21 is damaged, the user only needs to replace the damaged LED light bar 21, and the rest of the LED light bar 21 can continue to be used, so as to reduce the costs of maintenance incurred.

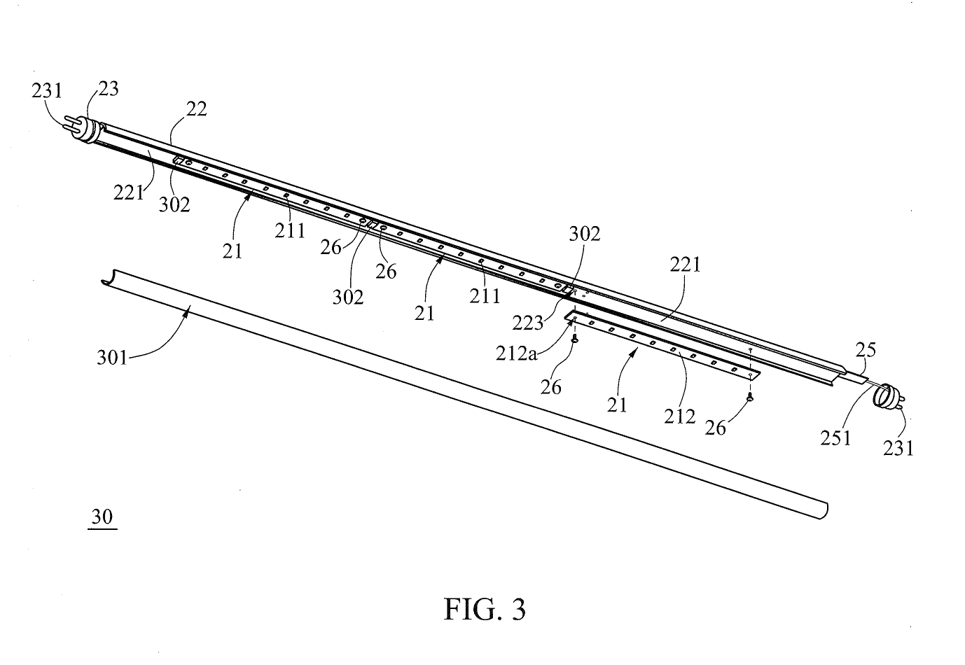

Refer to FIG. 3, FIG. 3 shows the LED lamp 30 of the second embodiment, the LED lamp 30 includes a lamp cover 301, the lamp cover 301 is assembled in the tube 22, and it's also a light emitting surface for the LED light bar 21. The lamp cover 301 not only prevents for the LED light bar 21 from the contamination of the outer environment, but also makes the LED light 211 light uniformly. Besides, the LED lamp 30 is provided with a plurality of positioning block 302 on the placement surface 211 thereof, and each one of the LED light bar 21 is abutting against at least one positioning block 302, the positioning block 302 can help LED light bar 21 to positioning the through hole 212a and the screw holes 223 location more accurate in the assembling. From the above, the length of LED light bar 21 is around in 15 cm to 60 cm, and in the better embodiment, the LED light bar 21 has a length of 30 cm.

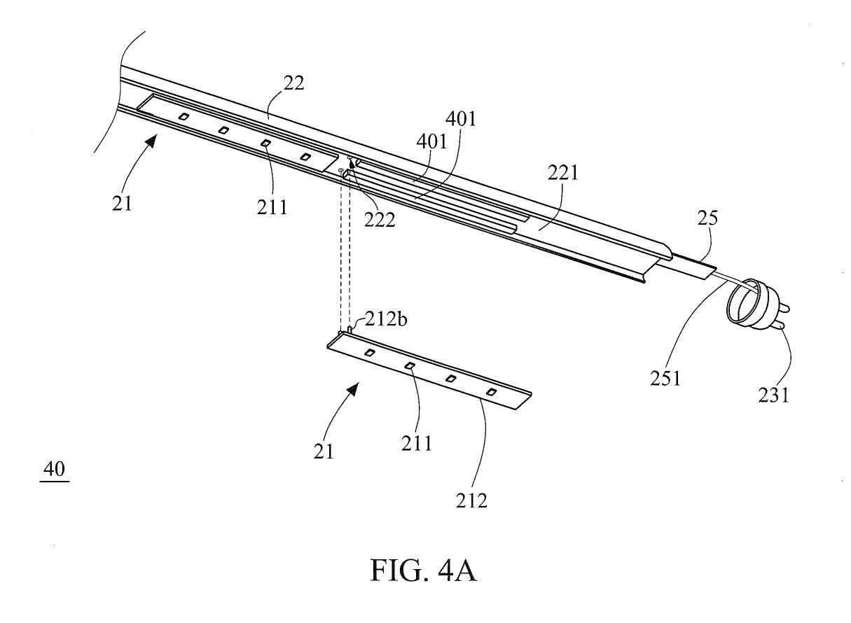

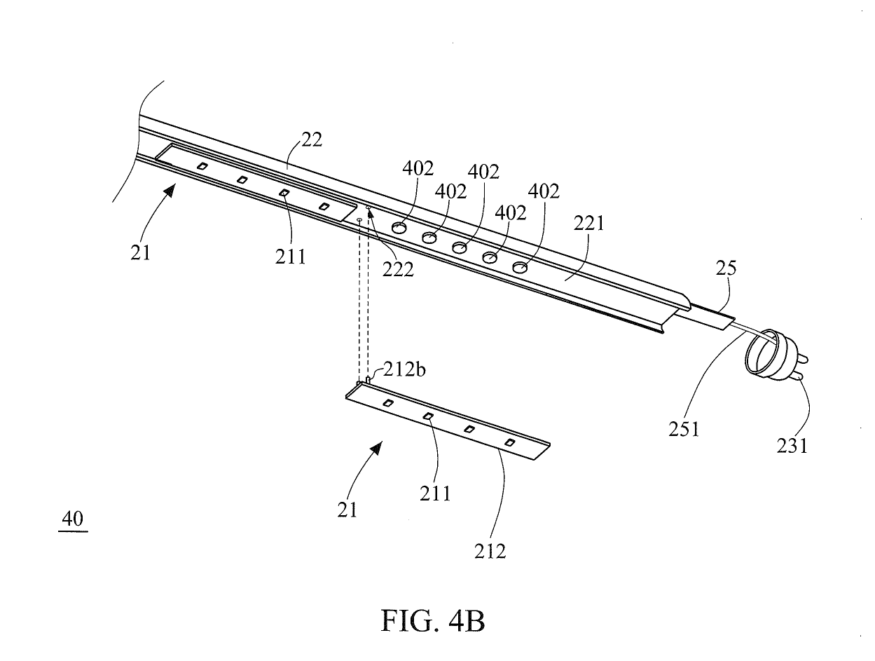

Refer to FIG. 4A, FIG. 4A shows the schematic diagram of LED lamp 40 of the third embodiment, the design of the LED lamp 40 is derived from the LED lamp 20. The LED lamp 40 has a plurality of long strip magnetic blocks 401 on the placement surface 221, the magnetic block 401 is such as a magnet, when the plug 212b of the LED light bar 21 is plugged into the socket 222, the magnetic blocks 401 will attract the top surface of the LED light bar 21 , so the LED light bar 21 can be placed on the placement surface 221. Thus if the LED light bar 21 is damaged, it's easily to be dispatched from the placement surface 221 of the LED light bar 21, and then to be replaced with a new LED light bar 21. In the above embodiment, each LED light bar 21 has two long strip magnetic blocks 401, but the person having ordinary skill in the art also can change the long strip of magnetic blocks 401 to a plurality of circular magnetic block 402 (refer to FIG. 4B), so that the circular magnetic blocks 402 can be regarded as multiple contact points to adsorption the LED light bar 21.

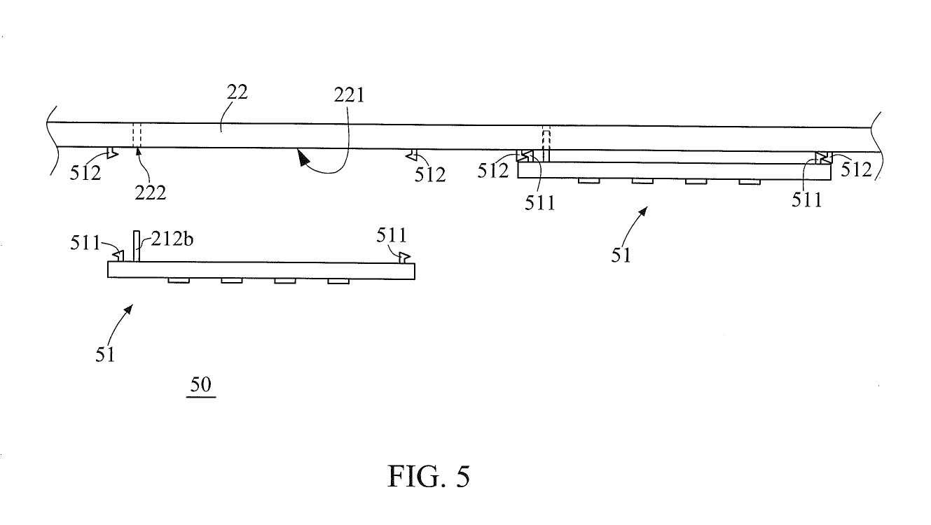

Refer to FIG. 5, FIG. 5 shows the sectional view of LED lamp 50 of the fourth embodiment, the LED light bar 51 of the LED lamp 50 has a first latch 511 at both end side, and the placement surface 221 has the second latch 512 which is corresponding to the first latch 511. When the plug 212b is plugged into the socket 222 on the placement surface 221, the first latch 511 and the second latch 512 are engaged with each other, so the LED light bar 51 can be placed on the placement surface 221.

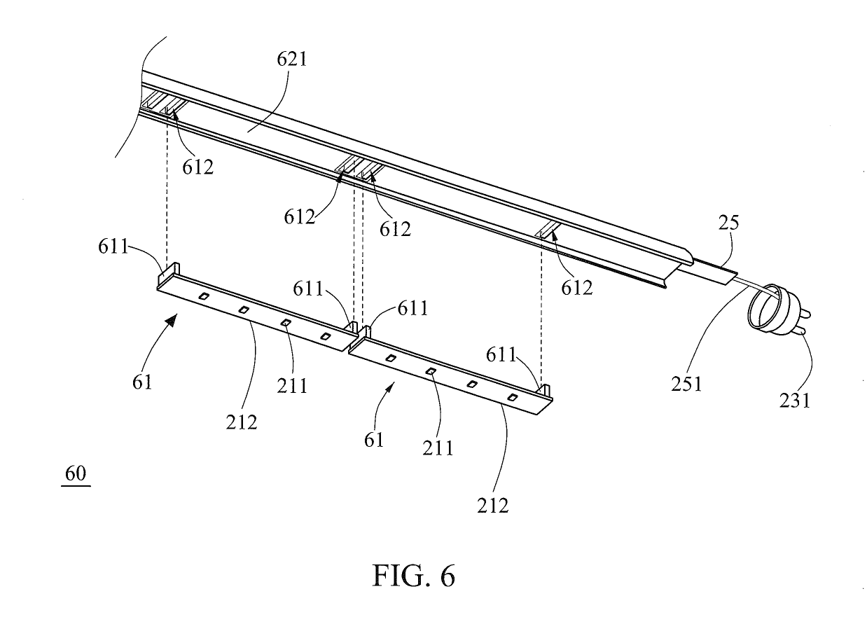

Refer to FIG. 6, FIG. 6 shows the fifth embodiment schematic diagram of LED lamp 60, the LED light bar 61 of the LED lamp 60 has two plugs 611, the two plugs 611 are located on the both ends side of the top surface, respectively. A socket 612 which is corresponding to the plug 611 are placed on the placement surface 621. When the plug 611 of the LED light bar 61 is plugged into the socket 612, the circuit board 212 from the LED light bar 61 will provide the power to the LED lights 211, and light the LED lights 211. The plug 611 plugged into the socket 612 not only receives the DC power, but also has interference fit with the socket 612, so the LED light bar 61 can be placed firmly on the placement surface 621. The LED lamp 60 of the fifth embodiment uses the USB plug 611 to connect with the USB socket 612, so as to make replacing the light bar 61 more conveniently.

In the above embodiment, the electricity to the LED light bar 61 is supplied by connecting the plug 611 and the socket 612. However, the person having ordinary skill in the art also can use a power line (not shown) which is set on the LED light bar connect with the connector on the tube (not shown, the connector also connects with the current converter), to supply the power of LED light bar.

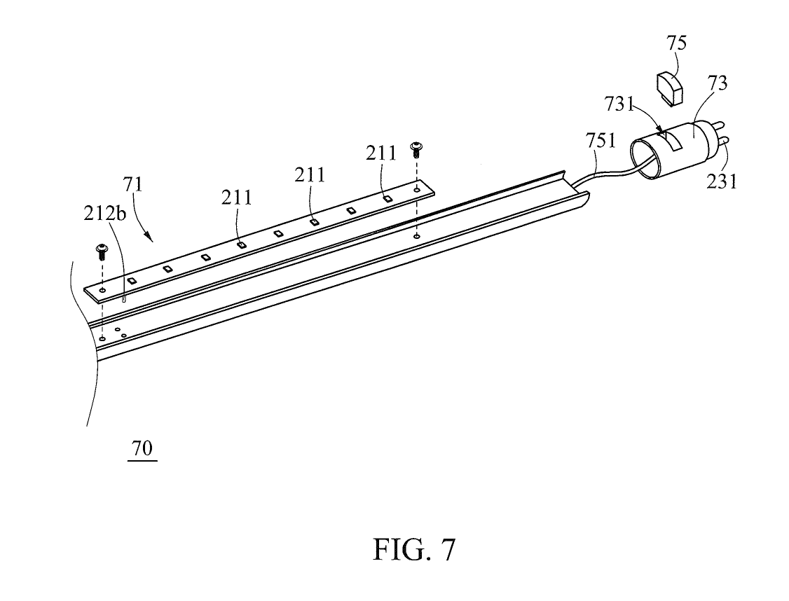

Refer to FIG. 7, FIG. 7 shows the sixth embodiment of LED lamp 70, the end cover 73 of the LED lamp 70 has a pit 731, a current converter 75 can be embedded in the pit 731. the current converter 75 set and embedded in the pit 731 are connected with a input wire 751, this kind of design can let the current converter 75 to receive the AC power directly from the electrode pair 231, the current converter 75 will transfer the AC power to DC power and transmits the DC power via the input wire 751 to the LED light bar 71.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. A LED lamp, including:
a tube, having a placement surface;
a plurality of LED light bar, placed on the placement surface, and each LED light bar including:
a circuit boards; and
a plurality of LED lights, placed on the circuit boards;
wherein the LED light bar is mounted on the placement surface in a detachable manner.

2. The LED lamp of claim 1, wherein the LED light bar is locked on the placement surface by at least one screw.

3. The LED lamp of claim 2, wherein the LED light bar which is locked on the placement surface by two screws, and these two screws are locked respectively on the two endpoints of the LED light bar.

4. The LED lamp of claim 1, further including a lamp cover, wherein the lamp cover is assembled with the tube, and the lamp cover is configure for the LED light bar's light emitting surface.

5. The LED lamp of claim 1, wherein a plurality of positioning blocks is placing on the placement surface, and each LED light bar is abutting against at least one positioning block.

6. The LED lamp of claim 1, wherein the placement surface has a plurality of magnetic blocks, and the LED light bar is placing on the placement surface by the magnetic blocks.

7. The LED lamp of claim 1, wherein the LED light bar has at least one plug, and at least one socket which is corresponding to the plug is placed on the placement surface, and the plug is shaped to make a interference fit with the socket, so as to make the LED light bar be mounted on the placement surface.

8. The LED lamp of claim 1, wherein the LED light bar which has a length between of 15 cm to 60 cm.

9. The LED lamp of claim 1, the LED light bar has a length of 30 cm.
